(19) United States
(12) Patent Application Publication
(10) Pub. No.: US 2017/0001048 A1
(43) Pub. Date: Jan. 5, 2017

(54) BLOWER FILTER DEVICE, RESPIRATORY PROTECTION DEVICE, OPERATIONAL INFRASTRUCTURE AND METHOD

(71) Applicant: DRÄGER SAFETY AG & CO. KGAA, Lübeck (DE)

(72) Inventors: Achim VOLMER, Lübeck (DE); Mathias DEHMKE, Lübeck (DE); Thomas PERNOT, Lübeck (DE); Marcus ROMBA, Ratzeburg (DE)

(21) Appl. No.: 15/039,694

(22) PCT Filed: Nov. 24, 2014
(86) PCT No.: PCT/EP2014/003125

§ 371 Date: May 26, 2016

(30) Foreign Application Priority Data
Nov. 28, 2013 (DE) 10 2013 018 053.8

(51) Int. Cl. A62B 9/00; F04D 29/42; F04D 29/28; F04D 25/08; F04D 25/06; H04W 4/00; A62B 9/04; A62B 18/00; A62B 18/04; A62B 17/04; A62B 18/02; F04D 29/70; A62B 23/02

(52) U.S. Cl. CPC A62B 9/006; F04D 29/703; F04D 29/4206; F04D 29/281; F04D 25/08; F04D 25/0673; A62B 23/02; A62B 9/04; A62B 18/006; A62B 18/045; A62B 17/04; A62B 18/02; H04W 4/008

(57) ABSTRACT

A blower filter device includes a blower unit that draws and delivers ambient air; a filter unit that filters a harmful substance, or a filter coupling to couple and uncouple the filter unit. A control unit is configured to actuate the blower unit, to determine an operating state of the blower filter device and/or other respirator system components and/or a respirator system (100) as a whole and to generate an alarm if a determined operating state indicates a disturbance. An output unit is configured to receive the alarm from the control unit and to output the alarm. A communication interface (228) is configured for wireless network integration and to transmit the alarm via the network (238). A respirator system (100) with such a blower filter device, an operational infrastructure (300) with such a respirator system, as well as a method of blower filter operation and operational infrastructure monitoring are provided.

### CROSS REFERENCE TO RELATED APPLICATIONS

This application is a United States National Phase Application of International Application PCT/EP2014/003125 filed Nov. 24, 2014 and claims the benefit of priority under 35 U.S.C. §119 of German Patent Application 10 2013 018 053.8 filed Nov. 28, 2013 the entire contents of which are incorporated herein by reference.

### FIELD OF THE INVENTION

The present invention pertains to a blower filter device, a respirator system respiratory protection device, an operational (use) infrastructure as well as methods for operating a blower filter device and for monitoring an operational infrastructure.

### BACKGROUND OF THE INVENTION

Respirator systems with blower filter devices are used for light and medium respiration protection and they support the user of respirator filters by reducing the respiration resistance, unlike conventional gas masks, and make possible a long, fatigue-free use of the respirator as a result.

A conventional respirator system has a blower filter device worn on the belt and a headpiece, which is designed as a hood or mask. The blower filter device and the headpiece are connected to one another via a tube. The (possibly contaminated) ambient air is drawn in through a filter by means of the blower filter device, as a result of which it is freed of harmful substances, and is subsequently sent via the tube to the headpiece in order to be fed to the user of the respirator. The blower filter device may have, among other things, a fan impeller driven by a motor and a spiral housing. The energy for the motor is provided by a battery. In addition, a control unit is present, which actuates the motor and can process inputs of the user. A protective housing encloses, as a rule, the blower unit, the control unit and the battery. At least one filter can be connected to the protective housing. In addition to the principal function of transporting air, the blower filter device additionally informs the user on the current operating state as well as especially malfunctions by means of visual or acoustic signals.

Reliable function of the respirator system is of vital importance for the user. Therefore, information on a malfunction of the device should also reach the user with certainty. Depending on the operating conditions, the user is, however, often unable due to the environmental situation to perceive visual signals if carrying the apparatus on the user's back or even acoustic signals in situations associated with a high noise level. It is also possible under adverse conditions that an alarm originating from a blower filter device is not perceived by the persons located in the vicinity in missions in which a plurality of persons work in a team; a mutual assistance is often difficult in such situations.

### SUMMARY OF THE INVENTION

One object of the present invention is to provide a blower filter device, a respirator system and an operational infrastructure as well as to propose methods for operating a blower filter device and for monitoring the operational infrastructure, in which the drawbacks of the state of the art are at least partly avoided. In particular, one object of the present invention is, in the particular aspects of the present invention, to improve the perceptibility of alarms from individual team members for other members of the team and to facilitate assistance by other team members. Another object of the present invention is to also make alarms from an individual team member better recognizable at a monitoring or mission command instance in order to make it possible to make better-founded decisions and to take suitable measures on the basis of improved information.

According to a first aspect, a blower filter device for a respirator system is provided, wherein the blower filter device has a blower unit, which is configured to draw in and to deliver ambient air; a filter unit, which is configured to filter at least one harmful substance out of the ambient air drawn in and being delivered, or a filter coupling unit for coupling in or on such a filter unit; a control unit, which is configured to actuate the blower unit, to determine an operating state of the blower filter device and/or of other components of the respirator system or of the respirator system as a whole, and to generate an alarm when the determined operating state indicates a disturbance; and an output unit, which is configured to receive and to output the alarm from the control unit. Further, a communication interface is provided according to the present invention, which is configured to be integrated in a network in a wireless manner and to transmit the alarm to other participants of the network.

In the sense of the present invention, a blower unit is a motor-driven device for delivering air, which may have, in general, a motor, a fan impeller and a fan housing. The fan housing may be accommodated or integrated in a protective housing of the blower filter device. The blower unit may advantageously be configured as a radial fan with a spiral housing and the motor may be supplied from a battery. Harmful substances are defined as gases, solid and/or liquid aerosols, which have a danger potential for the user of the respirator system. Filters may be, for example, absorption or catalytic filters for gases, particle filters for solid and/or liquid aerosols, or combination filters, which filter both particles and aerosols. A filter unit is defined, in particular, as an assembly unit with a filter, wherein the filter can often be arranged in the (axial) air feed path of the fan housing, but it may also be permanently integrated. Depending on the particular application, different (possibly replaceable) filter inserts may be present. A control unit may be, in the sense of the present invention, any suitable signal or data processing device. An operating state is defined in the sense of the present invention as a quantitative and/or qualitative assessment of operating parameters. Operating parameters may be, for example, a power consumption of a fan motor, a state of charge of a battery, a pressure difference between the delivery side and the suction side of the fan, an overpressure of the respirator system on the delivery side of the fan against the surrounding area, a coupling state of the filter unit, a degree of degradation of the filter unit, a (mechanical or pneumatic) state of connection between the blower filter device, a headpiece of the respirator system and optionally a connection tube, and the quality of reception of the communication interface. Operating parameters may be supplied by sensors, plug-type connections, circuits, etc. A disturbance may be defined in the sense of the present invention as any undesired state, especially a state in which reliable operation, especially the protection of the user, is not guaranteed any longer. An output unit is defined as a device that is configured to output signals in an acoustic and/or optical and/or sensory manner. An acoustic output may be effected, for example, by a loudspeaker; an optical one by a signal light or an LED or a screen unit or a combination thereof, and a sensory output may comprise, for example, a vibrating device. Other participants of the network may be, for example, blower filter devices or communication interfaces of other team members of a mission team, a central command, a room monitoring unit, a central monitoring unit, a gateway or the like. The control unit is configured in the sense of the present invention to direct the alarm in a specific manner not only to the output unit proper, but also to the communication interface, so that the alarm is also transmitted to other participants. For example, members of a mission team can be informed hereby among themselves of problems of other members, so that mutual assistance is facilitated. The perception of an alarm is improved. A central command or monitoring instance can intervene better and in a purposeful manner.

If the communication interface is configured, further, to receive alarms from other participants of the network (external alarms), the user of the device can also be alerted to problems of other team members.

In a preferred variant, the output unit is configured, furthermore, to output alarms received from other participants of the network. External alarms may be outputted either directly to the output unit or received by the control unit, possibly processed (selected, etc.) and then outputted to the output unit. Alarms that go back to a problem of its own (internal alarms) and external alarms can thus be outputted via one and the same output unit.

In another preferred variant, the output unit is configured to output alarms differently according to the origin and/or type of the particular alarm. Contrary to a uniform alarm, which is the same for all types of alarms, it can be made possible as a result to make a distinction between “primary alarms” and “secondary alarms,” as a result of which the user of the blower filter device can be alerted to a disturbance occurring at another member of the team, distinguishably from a disturbance of his own device or system. Other members of the team can also recognize from the manner in which the alarm of a blower filter device is outputted whether this device or system or another device or system is involved. If each participant is logged in in the network with an unambiguous code of his own, it is also conceivable that the alarm is individualized according to the code of the origin of the alarm. For example, different colors, which are shown, for example, on the clothing, on the helmet or the like, may be assigned to the members of a team participating in a team, and an optical display unit may be configured to light up or blink in the particular color depending on the origin of the alarm. Alarms that are triggered by a plurality of participants can thus also be outputted simultaneously or one after another, which further increases the safety of the team members. Furthermore, a general alarm (evacuation alarm), which can likewise be outputted in a specific manner, can be transmitted by a central command (monitoring unit).

The communication interface is advantageously configured to operate with a standardized wireless technology and with a corresponding protocol. In a preferred embodiment, this is selected from a group that has Bluetooth, ZigBee, Ant, WLAN and similar wireless technologies.

In a preferred variant, the communication interface has a Gateway function in order to transmit received messages to other participants. As a result, redundancy can also be achieved in the transmission of messages in case of difficult transmission conditions, for example, within a building, in the presence of other obscurations, in case of external radiation sources, etc.

The blower filter device is preferably configured such that it can be worn on the body or on the clothing, especially on a belt, of a person.

According to another aspect of the present invention, a respirator system is proposed, which has a headpiece, which is configured to be worn on the head of a person; a blower filter device, which is configured to deliver and filter ambient air; and a connection unit for the pneumatic coupling of the headpiece with a delivery side of the blower filter device. According to the present invention, the blower filter device is configured in this respirator system according to the above description.

It is preferred that the headpiece is a helmet, a fixed or inflatable hood or a breathing mask. The connection unit may be permanently or detachably coupled with the headpiece and/or with the blower filter device. In case of a detachable coupling, a coupling structure may have means either for failsafe coupling or for generating information (data structure, signal, etc.), which can be fed to the control unit and which represents an error-free or non-error-free coupling state. The control unit can thus recognize, for example, a non-error-free coupling of the connection or a connection unit or coupling that is not suitable at all and qualify a disturbance as an operating state.

According to another aspect of the present invention, an operational infrastructure is proposed, which has at least one respirator system according to the above description and a wireless network, which is adapted to the communication interface of the blower filter device of the at least one respirator system.

The operational infrastructure preferably has at least one additional participant, which is selected from the group that comprises:

a monitoring unit,
an alarm generator, and
a measuring unit,
wherein each participant has a wireless communication interface, which is configured to be incorporated in the wireless network and to transmit alarms to and/or to receive alarms from all or selected participants.

A monitoring unit is defined as a mission central command or the like, which is often set up outside a concrete area of use and which plays a central role for additional participants of the operational infrastructure by monitoring and coordinating the mission. The monitoring unit may have a higher rank than the other participants. The monitoring unit may be embodied, for example, by a mobile computer or a mission central command, which may have a built-in communication interface. However, the present invention is not limited to this. For example, the monitoring unit may also be a vehicle used in the mission or a mission command center. A measuring unit is defined as an individual or distributed, modular or integrated device, which has, for example, sensors for measuring ambient parameters, such as temperature, pressure, oxygen level, the level of harmful substances (summary level or separately according to individual harmful substances). An alarm generator is defined as an individual or distributed, modular or integrated device for outputting an ambient alarm (siren, loudspeaker, blinking light, all-round lights, light cannon, flickering LED light, etc.). It is obvious that each of the participants mentioned as examples may be present as a plurality of participants.

Another aspect of the present invention pertains to a method for operating a blower filter device for a respirator system, the method having the method steps to be carried out by the blower filter device:

determination of an operating state of the blower filter device and/or of other components of the respirator system or of the respirator system as such;
generation of an alarm when the determined operating state indicates a disturbance;
outputting of the alarm; and
transmission of the alarm via a network to other participants of the network by means of wireless communication.

Another aspect of the present invention pertains to a method for operating a blower filter device for a respirator system, the method having the method steps to be carried out by the blower filter device:

receiving an alarm via a network from another participant of the network by means of wireless communication, and
outputting the alarm.

Another aspect of the present invention pertains to a method for monitoring an operational infrastructure with at least one respirator system, the method having the method steps:

receiving an alarm via a network from one of the at least one respirator system by means of wireless communication, and
transmitting the alarm to other participants of the network via the network by means of wireless communication.

The at least one respirator system is, by definition, a participant of the network, and the method for monitoring the operational infrastructure is performed, by definition, by another participant of the network, preferably a monitoring unit, such as a central command

Since the methods according to the present invention reflect the functions of the blower filter device and respirator system according to the present invention and of the operational infrastructure according to the present invention, they offer the same advantages as those already described.

Further features, objects and effects of the present invention appear from the description and the attached drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a respirator system according to an exemplary embodiment of the present invention;

FIG. 2 is a block diagram of the respirator system from FIG. 1;

FIG. 3 is a schematic view of an operational infrastructure according to an exemplary embodiment of the present invention;

FIG. 4 is a flow chart of a process on the side of a respirator system according to an exemplary embodiment of the present invention; and

FIG. 5 is a flow chart of a process on the side of a monitoring unit of the operational infrastructure according to an exemplary embodiment of the present invention.

### DESCRIPTION OF THE PREFERRED EMBODIMENTS

Exemplary embodiments of the present invention will be described below in detail on the basis of the attached drawings. Identical components shown in different figures are always designated by the same reference numbers. Components and features, purposes and effects, which are described in reference to an exemplary embodiment, are to be assumed to be applicable in all other exemplary embodiments, unless this is expressly or obviously ruled out, and they shall also be considered to be disclosed in reference to the respective other exemplary embodiment, even if they are not expressly shown and/or described there. It is obvious, furthermore, that the drawings shall be considered to be schematic drawings and no restrictions in respect to concrete dimensions or size ratios shall be attributed to them, unless such restrictions are expressly described.

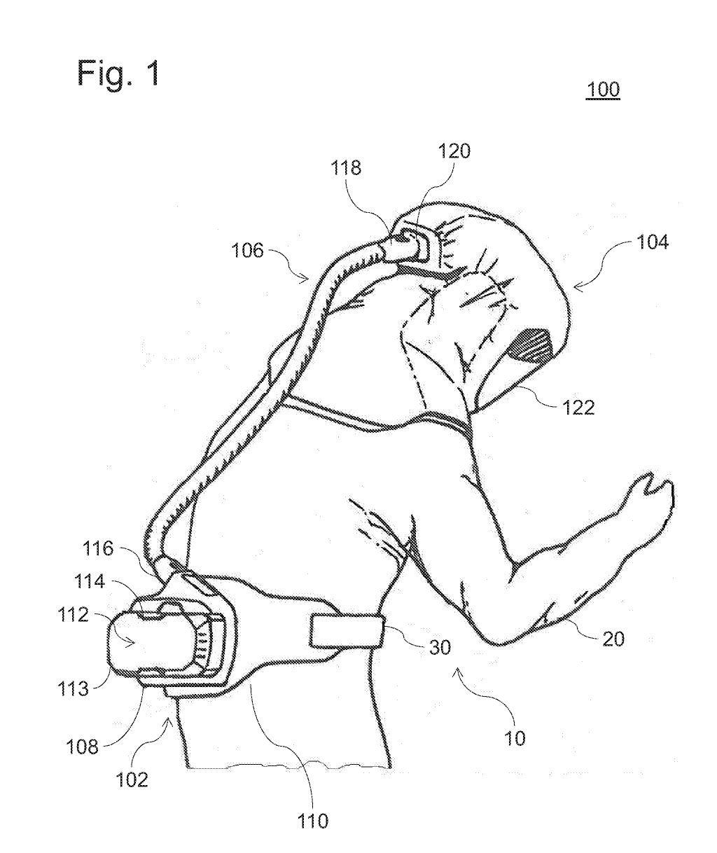

FIG. 1 schematically shows a respirator system 100 as an exemplary embodiment of the present invention. The respirator system 100 is carried by a person 10, who wears a protective clothing 20 with a belt 30. The respirator system 100 has a blower filter device 102, a headpiece 104 and a connection unit 106. The blower filter device 102 has a protective housing 108, which is mounted on a base plate 110, which is in turn fastened to the belt 30 of the person 10. The belt 30 may be part of the blower filter device 102, but it may also be integrated with the base plate 110. In a variant, the protective housing 108 may be fastened without a base plate 110 to the belt 30, or the base plate 110 may be a part of the protective housing 108. A filter unit 112 is detachably fastened to the protective housing 108. The filter unit 112 has a filter housing 113 with two recessed grips 114, which facilitate the removal and mounting of the filter unit 112 on the protective housing 108.

The connection unit 106 has the form of a tube with two connection pieces 116, 118 and establishes a pneumatic connection between a delivery side of a blower unit (not visible) installed in the protective housing 108 and a connection part 120 of the headpiece 104. In other words, air delivered and filtered by the blower unit of the blower filter device 102 is fed to the headpiece 104 via the connection unit 106. The headpiece 104 is designed in this embodiment as a hood, which is seated on a shoulder part of the person 10 and is closed sufficiently tightly. In one embodiment variant, the headpiece may be permanently connected to the protective clothing 20; the protective clothing 20 with the headpiece 104 would be able to be considered to be a part of the respirator system 100 in this variant. The headpiece has a visor 122 with a comparatively large-surface eye-protecting lens. In an alternative embodiment, the headpiece 104 may be designed as a gas mask (full mask or half mask). A gas mask differs from a hood solution, as far as the present invention is concerned, among other things, in the tightness of seating and thus in the pressure conditions and the volume flow to be provided by the blower filter device 102. In tight-fit headpieces (tight-fit configuration), the volume flow is, for example, 115 L/minute to 145 L/minute, without limitation of the general specification, and 170 L/minute to 190 L/minute in case of loose-fit headpieces (loose-fit configuration) because of the greater losses due to leaks. It is obvious that these numerical data are purely exemplary and do not restrict the present invention. It should be pointed out that the blower filter device 102 may cooperate with different types of headpieces. The volume flow to be provided may be entered, for example, manually and/or configured automatically via a code (e.g., scanned pins in the blower-side connection piece 116, which code the type of the headpiece) and/or regulated by means of pressure sensing.

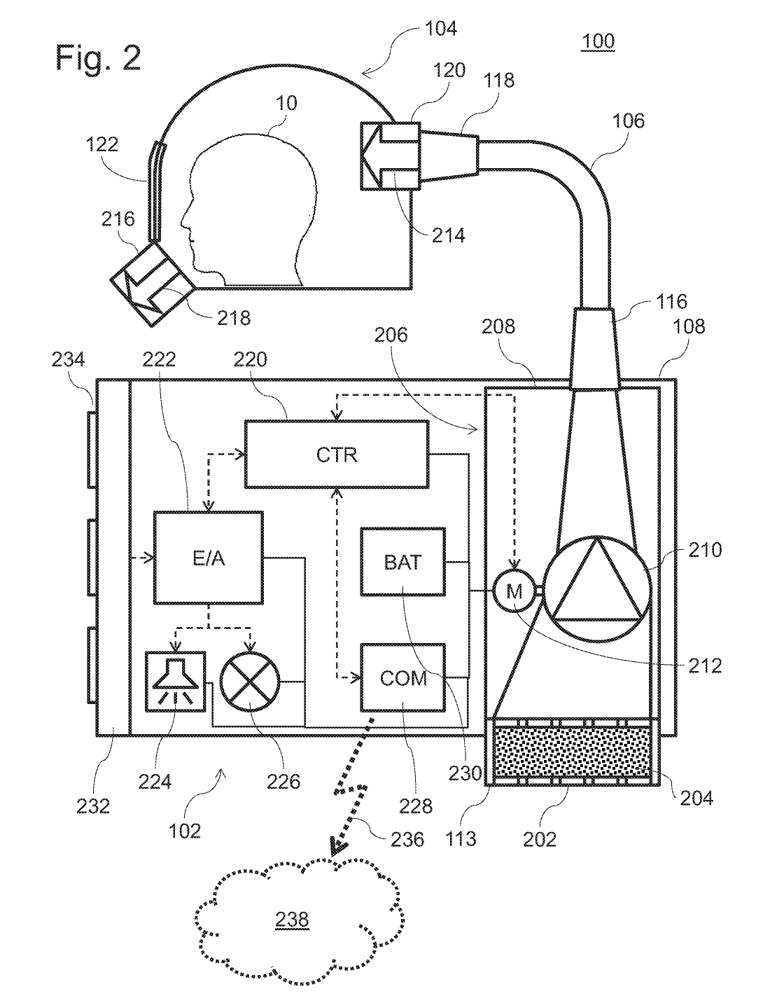

FIG. 2 shows a block diagram of the respirator system 100 from FIG. 1.

According to the view in FIG. 2, the filter housing 113 of the filter unit 112 is inserted into a filter mount (not specifically designated) of the protective housing 108. The filter housing 113 has a number of air passages 202 and accommodates a filter insert 204. Without limitation of the general specification, the filter insert 204 is a combination filter insert with a gas filter and with an aerosol filter. The selection of the filter insert 204 depends in practice on the operating conditions and may be selected in any way desired in respect to the present invention.

The above-mentioned blower unit 206 is also accommodated in the protective housing 108. The blower unit 206 has a fan housing 208, which has the form of a spiral housing without limitation of the general specification. The protective housing 108 has the form of the fan housing 208 approximately as it is seen in FIG. 1. The fan housing 208 accommodates a fan impeller 210 and a fan motor 212 for driving the fan impeller 210. The suction side of the fan housing 208 adjoins the filter housing 113. The blower-side connection piece 116 of the connection unit 106 is connected on the delivery side of the fan housing 208.

The head-side connection piece 118 of the connection unit 106 is connected, as is seen already in FIG. 1, to a connection part 120 of the headpiece 104. The connection part 120 has a nonreturn valve 214, which presets the direction of flow from the connection unit 106 towards within the headpiece 104 and blocks a backflow. Furthermore, the headpiece 104 has an exhalation part 216 with a nonreturn valve 218, which presets the direction of flow from the inside to the outside and blocks a backflow.

In addition to the blower unit 206, a control unit (CTR) 220, an input/output interface (E/A) 222, a loudspeaker 224, a light 226, a communication interface (COM) 228, and a battery (BAT) 230 are also accommodated in the protective housing 108 of the blower filter device 102. The loudspeaker 224 and the light 226 form a display unit in the sense of the present invention. An input unit 232 with a plurality of buttons 234 is also arranged on the protective housing. Without limitation of the general specification, the battery 230 is a secondary battery, i.e., a rechargeable battery. Without limitation of the general specification, the battery 230 can be connected to a charger via a connection jack, not shown in detail, arranged on the protective housing 108, and it can thus be charged. In one embodiment variant, the battery 230 may also be placed removably in the protective housing 108, so that the battery 230 is replaceable and may possibly also be charged externally. According to the view in FIG. 2, the battery 230 is connected to the control unit 220 and to additional consumers 212, 222, 224, 226, 228, and it supplies these with energy, while the control unit 220 is connected to the additional components for signal technology only. In one embodiment variant, the battery 230 may be connected to the control unit 220 only and the control unit 220 can distribute the energy necessary for the operation to the consumers.

The input/output interface 222 is connected for signal technology to the control unit 220, the display unit (loudspeaker 224, light display 226) and the input unit 232 (signal technological connections are indicated by broken thin lines in FIG. 2) in order to signal inputs, which are effected with the buttons 234 of the input unit 232, to the control unit 220 and to signal messages and/or signal sequences, which are received or generated by the control unit 220, at the loudspeaker 224 or the light 226. The control unit 220 is also connected for signal technology to the fan motor 212 in order to control the power consumption of the fan motor 212. Furthermore, the control unit 220 is connected for signal technology to the communication interface 228, and the communication interface 228 is capable of establishing a wireless connection 236 with a network 238. The control unit 222 can signal in this manner messages to the communication interface 228 for wireless transmission to the network 238 and the communication interface 228 can signal messages received from the network 236 in a wireless manner to the control unit 220.

Without limitation of the general specification, the communication interface 228 operates on the basis of the Bluetooth technology class 1, which is standardized with a range of up to 100 m. Depending on the conditions of use and the operating conditions, it is also possible to use other wireless technologies in embodiment variants. The communication interface 228 preferably also has a functionality as a gateway, as a result of which received messages can also be forwarded in a wireless manner for reception by other receivers, for example, communication interfaces of an identical or analogous design of other blower filter devices or respirator systems.

It should be noted that the blower filter device 102 in itself is also an exemplary embodiment of the present invention.

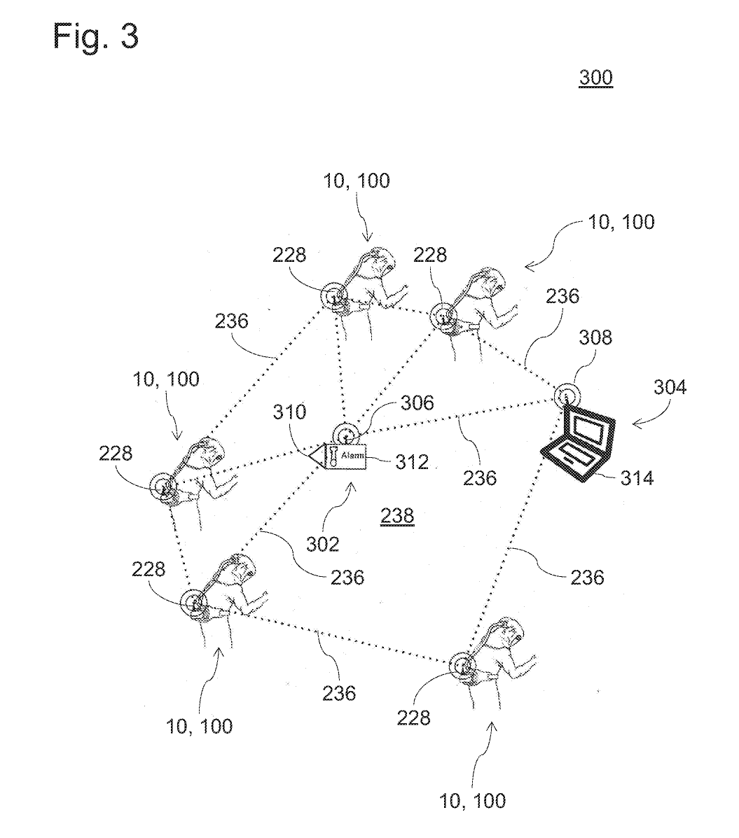

FIG. 3 schematically shows an operational infrastructure 300 of a team of five persons 10, which is another exemplary embodiment of the present invention.

The operational infrastructure 300 has, for each person 10, a respirator system 100 according to the above description. In particular, each respirator system 100 is equipped with a wireless communication interface 228 according to the above description. The operational infrastructure 300 has, further, an on-site unit 302 and a monitoring unit 304. The on-site unit 302 has a wireless communication interface 306, and the monitoring unit 304 has a wireless communication interface 306, so that the on-site unit 302 and the monitoring unit 304 can also be connected to the network 238 via a wireless connection 236. According to the view in FIG. 3, the network 238 has the form of a mesh. In embodiment variants, the network 238 may also be in the form of a star, a tree, a ring or a chain.

The on-site unit 302 has a measuring unit 310 and an alarm generator 312. The measuring unit 310 may have, without limitation of the general specification, a temperature sensor and an oxygen sensor in order to measure the ambient temperature and the oxygen level on site, i.e., at the site of the persons 10 involved in the mission. Further measuring means may pertain, depending to the operating conditions, to the atmospheric pressure, the levels of harmful substances, radiation load, etc. The alarm generator 312 may have, without limitation of the general specification, a bell and an all-round light. Upon initiation by the monitoring unit 304, a general alarm, which shall prompt the persons 10 to evacuate the site of the mission (evacuation alarm), may be outputted via the alarm generator 312. The alarm generator 312 may also be set up to output different types of alarms, warnings, messages, announcements or instructions. The on-site unit 302 may also be set up to process measured values of the measuring unit 310 by means of a control unit, not shown more specifically, and to automatically output an evacuation alarm in the presence of certain conditions. Instead of a bell, a siren, a loudspeaker or the like may be present as well, and a blinking light, a flickering LED light, a light cannon or the like may also be provided instead of an all-round light.

The monitoring unit 306 also has a data processing means 314, which is shown as a laptop computer in FIG. 3. It is obvious that this view is only an example and may be modified as desired according to the needs. The communication interface 308 of the monitoring unit 304 may be coupled with or integrated in the data processing means 314.

Like the communication interfaces 238, the communication interfaces 306, 308 are capable of establishing a wireless connection 236 with the network 238. In particular, each communication interface 228, 306, 308 may be connected, in principle, to any of the other communication interfaces 228, 306, 308 via a wireless connection if this is permitted by the distance and the other transmission conditions. If a person can build up a wireless connection 236 with a single other person 10, such as, for example, the person 10 shown at the bottom in FIG. 3, and with the monitoring unit 304, rather than with all participants, which may happen, for example, because of an isolated position during the mission or obscuring or interfering ambient conditions, this person 10 still always has a connection to all participants in the network 238, because all communication interfaces 228, 306, 308 also have a gateway function.

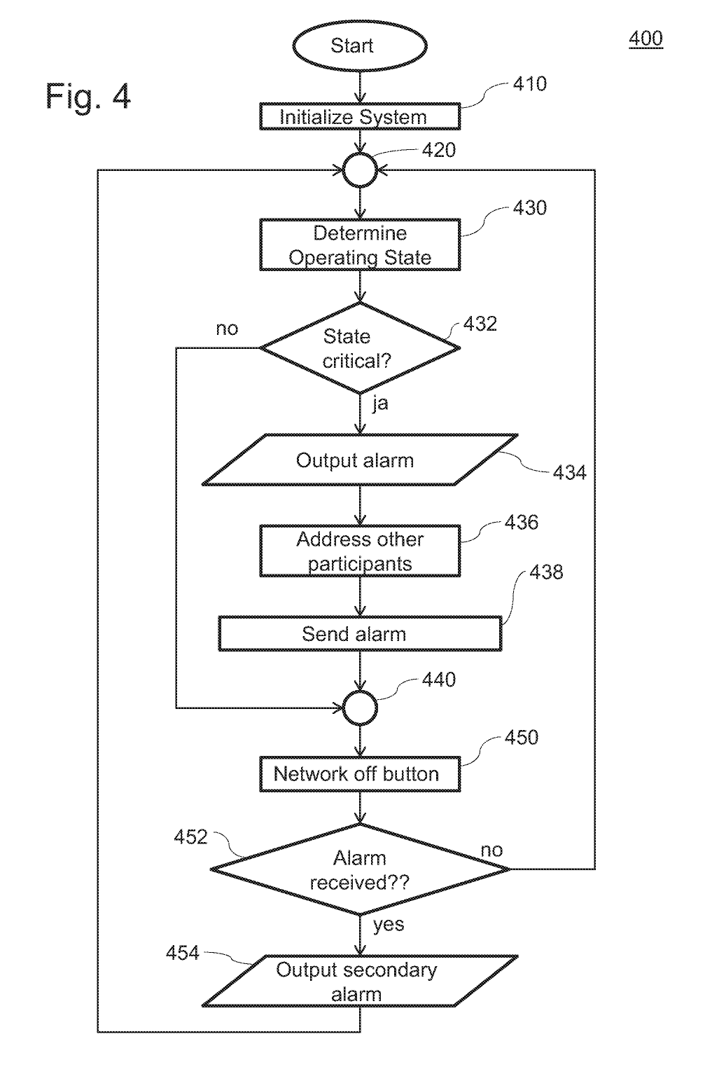

FIG. 4 shows the course of an exemplary process 400, which can be carried out by the control unit 220 of the blower filter device 102 from FIG. 2 and is an exemplary embodiment of the present invention.

The process 400 can be started, for example, by pressing a button 234 on the input unit 232 (FIG. 2), as a result of which the blower filter device 102 is switched on. After the start of the process, the system is initialized in a step 410. More precisely, the control unit 220 loads a possible operating system, tests the ability of that system to function, performs the deletion and/or first loading of memory contents, and puts all elements of the blower filter device on standby. A communication may also take place already with the network at the time of the initialization in order to log in with an unambiguous code in the network.

Via a transition point 420, the processing then leads to a step 430, in which an operating state of the respirator system is determined. For example, a state of charge of the battery 230, a state of connection of the communication interface 228 to the network 238, a power consumption of the fan monitor 212, a state of (mechanical or pneumatic) connection of the connection unit 106 with the blower filter device 102 and with the headpiece 104, a differential pressure of the fan unit (difference between the delivery side and the suction side) or an overpressure of the delivery side against the ambient pressure, etc., are detected in step 430 by suitable sensors, contacts or the like, analyzed by the control unit 220, and the operating state is determined and possibly assessed from this. The operating state may be, for example, “OK” or “critical.”

It is assessed in a subsequent step 432 whether the operating state is critical or not. If the assessment in step 432 shows that the operating state is critical, the processing proceeds to step 434, in which an alarm is outputted via the output unit 224, 226 (FIG. 2). More precisely, the control unit 220 prompts the input/output interface 222 to forward the alarm to the loudspeaker 224 and/or the light 226 (cf. FIG. 2), which prompts the latter to output the alarm corresponding to the content thereof

After outputting the alarm in step 434, the process proceeds to step 436, in which other participants of the network 238 are addressed. More precisely, the control unit 220 prompts the communication interface 228 to build up the connection 236 to the network 238 (FIG. 2) and to determine which communication interfaces 228, 308, 306 (FIG. 3) of the network 238 can be reached, and to establish a connection to the corresponding communication interfaces. The alarm is then forwarded to the addressed participants in step 438. In other words, the control unit 220 prompts the communication interface 228 to send a message, which contains information that corresponds to the outputted alarm, to the participants being addressed via the connection 236 until an acknowledgement of receipt is received from all addressed participants or a permissible transmission time is exceeded. The processing then proceeds to a transition point 440, and the processing also proceeds directly to this transition point if the result of the assessment in step 432 is negative.

The transition point 440 leads further to a step 450, in which the network 238 is scanned More precisely, the control unit 220 prompts the communication interface 228 to scan the network 238 via the connection 236 for messages (e.g., alarms), which are addressed by other participants to this system, and to forward transmitted messages to the control unit 220.

It is subsequently assessed in step 452 whether an alarm (i.e., a message which contains an alarm), was received by another participant. If the assessment in step 452 shows that it was, a secondary alarm is outputted via the output unit 224, 226 (FIG. 2) in the next step 454. More precisely, the control unit 220 generates the secondary alarm, which differs from the alarm (internal alarm) outputted in step 434, and it prompts the input/output interface 222 to forward the secondary alarm to the loudspeaker 224 and/or the light 226 (cf. FIG. 2), which prompts these to output the secondary alarm. After the output of the secondary alarm in step 454, the processing jumps back to the transition point 420, and the processing is also routed directly to this transition point if the result of the assessment in step 454 was negative.

In other words, as long as the operating state is OK and no alarms are received from other participants, there is a cycling in the loop comprising the steps 430, 432: no, 450 and 452: no time and time again. If a critical operating state is determined (step 432: yes), a branch consisting of the steps 434-438 is processed in order to output both an alarm (internal alarm) at the own blower filter device and to forward the alarm to all addressable participants in a wireless manner. If an alarm (external alarm) is received from another participant (step 452: yes), a branch consisting of step 454 is processed, which forwards the alarm of another participant as a secondary alarm at the own blower filter device. After passing through the branches for outputting the alarm and/or the secondary alarm, the processing always goes back to the transition point 420 in order to start the loop anew.

A person 10, who carries the blower filter device 102 according to the present invention, can recognize from the secondary alarm outputted at the own blower filter device 102 that another person 10 of the team possibly needs help, even though he has visual or acoustic contact with the person 10 in question. The secondary alarm outputted differs from the outputted internal alarm. For example, the internal alarm may consist of a continuous tone and/or a continuous light, while the secondary alarm consists of an interrupted tone and/or a blinking light. The user of the blower filter device 102 can therefore make a distinction between whether his own respirator system has a disturbance or another participant needs help. Each person 10 can also recognize from the type of the alarm at the blower filter device of another person 10 whether that person himself or another person needs help. The secondary alarm may also assume a number of different forms. For example, different criticality levels may be provided, or a secondary alarm may assume a certain characteristic form (e.g., of a siren and/or of a flickering light) when an evacuation alarm is received. The persons 10 may have been trained in advance to respond appropriately to different forms of alarms.

In a variant of the view shown in FIG. 4, the process can jump back directly to the transition point 420 after the internal alarm had been forwarded in step 438. The internal alarm is prioritized in this variant, so that secondary alarms are suppressed if there is a disturbance in the own respirator system.

In an expansion of the process 400, provisions may be made for a critical state to be able to be canceled manually via the input unit 232 and/or for certain limit values to be able to be changed manually and/or for a secondary alarm to be able to be suppressed manually and/or for an emergency message to be able to be triggered manually and also to be transmitted to other participants.

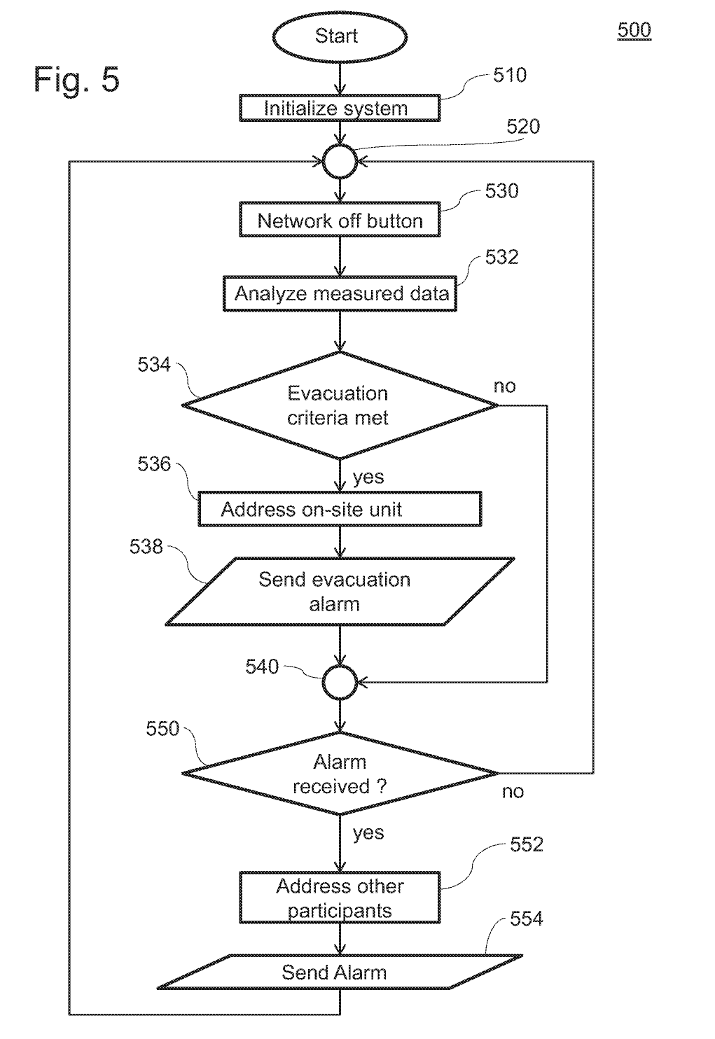

FIG. 5 shows the course of an exemplary process 500, which can be carried out by the monitoring unit 304 of the operational infrastructure 300 shown in FIG. 3 and is an exemplary embodiment of the present invention.

The process 500 can be started, for example, by switching on the data processing means 314 (FIG. 3) or by activating an application thereon. After the start of the process, the system is initialized in a step 510. More precisely, the data processing means 314 is booted up or it loads the application into the working memory, tests the ability of its components to function and especially the ability of the communication interface 308 to function, logs in with an unambiguous code on the network 238 and reports standby when the initialization has been successfully concluded.

Via the transition point 520, the processing then proceeds to a step 530, in which the network 238 is scanned. More precisely, the data processing means 314 prompts the communication interface 308 to scan the network 238 via the connection 236 for messages that are addressed by other participants to the monitoring unit 304 and to make available received messages (see FIG. 3). Measured data, which were transmitted especially from the on-site unit 302 or other measuring units as messages, are analyzed in a next step 532. The measured data may pertain, for example, to a temperature, an oxygen level, levels of harmful substances, radiation levels, etc.

It is assessed in a next step 534 whether certain, predefined evacuation criteria are met or not. Evacuation criteria may comprise, for example, oxygen levels below a certain oxygen level, radiation levels exceeding certain radiation levels, temperatures above or below certain temperature limits or the presence of other conditions, which may jeopardize the life and/or health of the persons 10 (FIG. 3) or the ability of the working device to function or generally the sense or success of the mission. If the result of the assessment in step 534 is positive, the processing proceeds to step 536, in which the on-site unit 302 (FIG. 3) is addressed. In other words, the data processing means (processor) 314 prompts the communication interface 308 to build up the connection 236 to the network 238 and, if possible, to establish a connection to the communication interface 308 of the on-site unit 302. The alarm is then outputted in step 538 to the on-site unit 302. In other words, the data processing means 314 prompts the communication interface 308 to send a message with information that corresponds to the alarm to the on-site unit 302 until an acknowledgment of receipt is received or a permissible transmission time is exceeded. The processing then proceeds to the transition point 540, and the processing is also routed directly to this transition point if the result of the assessment in step 534 is negative. Even through not shown in the figure, an addressing of all other participants may be attempted if it is not possible to address the on-site unit and to send the evacuation alarm to all addressed participants. If addressing is not possible any more at all (collapse of the network 238), the data processing means 314 may output a separate alarm at the location of the monitoring unit 304 (screen alarm, siren, etc.), so that evacuation of the area of the mission by a rescue team or other measures can be initiated.

The transition point 540 leads further to a step 550, in which it is assessed whether an alarm was received from another participant. If the result of the assessment in step 550 is positive, the process proceeds to step 552, in which other participants of the network 238 are addressed. In other words, the data processing means 314 prompts the communication interface 308 to build up the connection 236 to the network 238 and to determine which communication interfaces 228, 306 (FIG. 3) of the network 238 can be contacted, and to establish a connection to the addressable communication interfaces. The alarm is then forwarded to the addressed participants in step 554. In other words, the data processing means 314 prompts the communication interface 308 to send a message with information that corresponds to the received alarm to the addressed participants (communication interfaces) until an acknowledgment of receipt is received from all addressed participants or a permissible transmission time is exceeded. The processing then jumps back to the transition point 520, and the processing is also routed directly to this transition point if the result of the assessment in step 550 is negative.

In other words, as long as the measured data received from the on-site unit are unobjectionable and no alarms are received from other participants, there is a cycling in the loop comprising the steps 530, 532, 534: no, 550: no time and time again. If the measured data meet an evacuation criterion (step 534: yes), a branch consisting of the steps 536-538 is processed in order to forward an evacuation alarm to the on-site unit 302 (or possibly to all addressable participants) in a wireless manner. If an alarm is received from another participant (step 550: yes), a branch consisting of the steps 552, 554 is processed, which forwards the alarm to other participants. After passing through the branches for outputting the evacuation alarm and/or to forward the (external) alarm, the processing goes back to the transition point 520 time and time again in order to start the loop anew.

In a variant of the view shown in FIG. 5, the process can jump directly to the transition point 520 after the evacuation alarm was outputted in step 538. This variant is based on the consideration that other alarms may be moved into the background in the presence of an evacuation alarm.

Although not shown in the figure, any evacuation alarm or other alarm may also be outputted to the location of the monitoring unit itself, for example, on the screen and/or in a sound system of the data processing unit 514. Further, measured data, which are received from the on-site unit 502 or other measuring means, can also be followed on the screen of the data processing unit 514. Further, it is also possible to intervene in the process 500 manually by triggering an evacuation alarm, for example, independently from the assessment in step 534, in order to prompt the on-site unit 302 to output the evacuation alarm. Provisions may also be made for an evacuation alarm or other alarm to be able to be canceled or suppressed manually via the data processing means 514 and/or for certain limit values to be able to be changed manually.

The present invention was described and illustrated in the figures above on the basis of preferred exemplary embodiments, embodiment variants, alternatives and modifications. These descriptions and views are purely schematic and do not limit the scope of protection of the claims, but are used only for the exemplary illustration thereof. It is obvious that the present invention may be carried out and varied in many different ways without going beyond the scope of protection of the patent claims.

The above-described order of the process steps is not obligatory, but it may be varied as desired, within meaningful limits. It is also possible to process different process steps or sections simultaneously.

The connection between the headpiece and the blower filter device does not have to be established via a tube. A connection unit may also be a direct plug-type connection. The blower filter device and the headpiece may be accommodated together in a kind of a knapsack, backpack or a back frame with shelf and even integrated structurally.

The distributed arrangement of the control unit, battery, E/A interface and communication interface in FIG. 2 is used for illustration only. Any desired degree of integration or distribution of the individual components may be provided. For example, a plurality of control units may be provided, which carry out individual functions among the plurality of functions described, or a plurality of functional units and/or interfaces may be combined in a single control unit.

While specific embodiments of the invention have been shown and described in detail to illustrate the application of the principles of the invention, it will be understood that the invention may be embodied otherwise without departing from such principles.

1. A blower filter device for a respirator system, the blower filter device comprising:
a blower unit configured to draw in and deliver ambient air;
a filter unit configured to filter at least one harmful substance out of the ambient air drawn in and delivered, or a filter coupling for coupling and uncoupling such a filter unit,
a control unit configured to actuate the blower unit, to determine an operating state of the blower filter device or to determine an operating state of other components of the respirator system or to determine an operating state of the respirator system as a whole or to determine an operating state of any combination of the blower filter device other components of the respirator system and the respirator system as a whole and to generate an alarm based on a determined operating state indicating a disturbance;
an output unit configured to receive the alarm from the control unit and to output the alarm;
a communication interface configured to be wirelessly integrated in a network and to transmit the alarm to other participants of the network.

2. A blower filter device in accordance with claim 1, wherein the communication interface is further configured to receive alarms from other participants of the network.

3. A blower filter device in accordance with claim 2, wherein the output unit is further configured to output alarms received from other participants of the network.

4. A blower filter device in accordance with claim 2, wherein the output unit is configured to output alarms differently according to origin or alarm type or both alarm origin and alarm type.

5. A blower filter device in accordance with claim 1, wherein the communication interface is configured to operate with at least one wireless technology and with a corresponding protocol, which are selected from the group that comprises Bluetooth, ZigBee, Ant and WLAN.

6. A blower filter device in accordance claim 1, wherein the communication interface has a gateway function in order to transmit received messages to other participants.

7. A blower filter device in accordance claim 1, wherein the blower filter device is configured such that the blower filter device can be worn on a body of a user or on clothing of the user or on a belt of the user.

8. A respiratory protection system, comprising:
a headpiece -configured to be worn on the head of a person;
a blower filter device configured to deliver and filter ambient air; and
a connection unit pneumatically coupling the headpiece with a delivery side of the blower filter device, the blower filter device comprising:
a blower unit configured to draw in and deliver ambient air;
a filter unit configured to filter at least one harmful substance out of the ambient air drawn in and delivered, or a filter coupling for coupling and uncoupling the filter unit;
a control unit configured to actuate the blower unit, to determine an operating state of the blower filter device or to determine an operating state of other components of the respirator system or to determine an operating state of the respirator system as a whole or to determine an operating state of any combination of the blower filter device, other components of the respirator system and the respirator system as a whole and to generate an alarm based on a determined operating state indicating a disturbance;
an output unit configured to receive the alarm from the control unit and to output the alarm; and
a communication interface configured to be wirelessly integrated in a network and to transmit the alarm to other participants of the network.

9. A respiratory protection system in accordance with claim 8, wherein the headpiece is a helmet, a fixed or inflatable hood, or a gas mask.

10. Operational infrastructure, comprising:
a wireless network;
at least one respirator system comprising:
a headpiece configured to be worn on the head of a person;
a blower filter device configured to deliver and filter ambient air; and
a connection unit pneumatically coupling the headpiece with a delivery side of the blower filter device, the blower filter device comprising:
a blower unit configured to draw in and deliver ambient air;
a filter unit configured to filter at least one harmful substance out of the ambient air drawn in and delivered, or a filter coupling for coupling and uncoupling the filter unit;
a control unit configured to actuate the blower unit, to determine an operating state of the blower filter device or to determine an operating state of other components of the respirator system or to determine an operating state of the respirator system as a whole or to determine an operating state of any combination of the blower filter device, other components of the respirator system and the respirator system as a whole and to generate an alarm based on a determined operating state indicating a disturbance;
an output unit configured to receive the alarm from the control unit and to output the alarm; and
a communication interface configured to be wirelessly integrated in a network and to transmit the alarm to other participants of the network, wherein the wireless network is adapted to the communication interface of the blower filter device of the at least one respirator system.

11. Operational infrastructure in accordance with claim 10, further comprising at least one additional participant, which is selected from the group comprising:
a monitoring units;
an alarm generator; and
a measuring unit, wherein each participant has a wireless communication interface, which is configured to become integrated in the wireless network and to transmit alarms to all or selected participants or to receive alarms from all or selected participants or to both transmit alarms to all or selected participants and to receive alarms from all or selected participants.

12. A method of operating a blower filter device for a respirator system, the method comprising the steps of:
providing the blower filter device, the blower filter device comprising:
a blower unit configured to draw in and deliver ambient air;
a filter unit configured to filter at least one harmful substance out of the ambient air drawn in and delivered, or a filter coupling for coupling and uncoupling the filter unit;
a control unit configured to actuate the blower unit, to determine an operating state of the blower filter device or to determine an operating state of other components of the respirator system or to determine an operating state of the respirator system as a whole or to determine an operating state of any combination of the blower filter device, other components of the respirator system and the respirator system as a whole and to generate an alarm based on a determined operating state indicating a disturbance;
an output unit configured to receive the alarm from the control unit and to output the alarm; and
a communication interface configured to be wirelessly integrated in a network and to transmit the alarm to other participants of the network;
determining an operating state of the blower filter device or of other components of the respirator system or of the respirator system as a whole or any combination of the blower filter device, other components of the respirator system and the respirator system as a whole;
generating an alarm if the determined operating state indicates a disturbance;
outputting the alarm; and
transmitting the alarm via a network to other participants of the network by wireless communication.

13. A method of operating a blower filter device according to claim 12, further comprising the steps of:
receiving the alarm via the network at another participant of the network by means of the wireless communications; and
outputting of the alarm at the other participant.

14. A method according to claim 14, further comprising the steps of:
receiving the alarm via the network from the blower filter device by wireless communications; and
transmitting the alarm to other participants of the network via the network by wireless communication.
